(19) United States
(12) Patent Application Publication
(10) Pub. No.: US 2024/0233385 A1
(43) Pub. Date: Jul. 11, 2024

(54) MULTI MODAL VIDEO CAPTIONING BASED IMAGE SECURITY SYSTEM AND METHOD

(71) Applicant: PYLER CO., LTD., Seoul (KR)

(72) Inventors: Se Eun KIM, Seoul (KR); Jae Ho OH, Seoul (KR); Dong Chan PARK, Gyeonggi do (KR)

(21) Appl. No.: 18/558,681

(22) PCT Filed: Oct. 24, 2022
(86) PCT No.: PCT/KR2022/016300

§ 371 Date: Nov. 2, 2023

(30) Foreign Application Priority Data
Dec. 30, 2021 (KR) 10-2021-0193393

(51) Int. Cl. G06V 20/52; G06V 10/44; G06V 20/70; G06V 40/20; G08B 21/02; H04N 21/488

(52) U.S. Cl. CPC G06V 20/52; G06V 10/44; G06V 20/70; G06V 40/20; G08B 21/02; H04N 21/4884

(57) ABSTRACT

The present invention relates to an image security system and method utilizing CCTV and the like, and, to an image security system and method using multi-modal video captioning. The image security method according to an embodiment of the present invention comprises steps in which: a video caption unit generates, from vision data including image frames formed in order of time series constituting video data, a video caption related to an object behavior within the vision data for each time-series section of the vision data; and a behavior analysis unit determines whether the video caption is related to a preset dangerous behavior, and generates an alarm notifying of a dangerous situation if the object behavior is related to the dangerous behavior.

### TECHNICAL FIELD

The present disclosure relates to an image security system and method using a CCTV, etc., and, more particularly, to an image security system and method using multi-modal video captioning.

### BACKGROUND ART

A CCTV is generally used as an image security system. An image that is taken by a CCTV can be checked after an incident occurs because the image is stored in a specific recording medium, but, in order to proactively recognize and cope with a case immediately after or before the case occurs, it is required to recognize and cope with a problematic action in real time immediately when the problematic action is seen on a CCTV screen. Accordingly, in the case of an area that needs to be always monitored, a person who monitors the area has to keep watching a CCTV screen for 24 hours, which realistically has limitations. Further, as the number of CCTVs exponentially increases, many personnel are required to monitor all CCTVs reaching several thousands. In practice, about 5000˜6000 cameras have been introduced in many cities, but the control personnel who manage the cameras are not more than about several dozens of people.

Accordingly, with the recent introduction of an intelligent CCTV, methods of performing real-time monitoring through an object detection technique and an image classification technique using the deep learning technology of artificial intelligence are under study. These monitoring methods based on artificial intelligence in the related art can be implemented in the sequence of object detection, region localization, object identification and tracking, object classification, danger detection, warning generation, etc.

However, since an artificial intelligence model has to have definition over a predetermined level in order to detect specific objects, low definition CCTVs have difficulty in accurate detection and need a huge amount of data for learning in each category. Monitoring systems based on artificial intelligence in the related art can detect only items of information about datasets learned for specific objects and scenes due to the characteristics of existing intelligent CCTVs, so it is difficult to infer non-learned information and sudden situations. Further, it is difficult to specify the kind and the classification range of an object, which is supposed to be learned, in the case of a video in comparison to an image, so there is limitation in application of the artificial intelligence models of the related art and it is difficult to use CCTV images as a generalized concept about the possibility of occurrence of specific criminal activities such as robbery and theft. Meanwhile, a set-top box having a caption reproduction function and a method for performing reproduction have been disclosed in Korean Patent Application Publication No. 10-2000-0042949 (published on Jul. 15, 2000).

### DISCLOSURE

### Technical Problem

An objective of the present disclosure is to detect behavior of an object on the basis of in-video vision and audio information in a video through an extensive in-video contextual analysis based on multi-modal video captioning, and to automatically provide situation recognition information.

### Technical Solution

The present disclosure is a multi-modal video captioning-based image security system and method. An image security method according to an embodiment of the present disclosure includes: creating a video caption related to behavior of an object in vision data, which include time-serial image frames constituting video data, from the vision data for each time-series section of the vision data by means of a video caption unit; determining whether the video caption relates to preset dangerous behavior by means of a behavior analysis unit; and generating an alarm notifying of a dangerous situation by means of an alarm unit when the behavior of the object relates to the dangerous behavior.

The creating of a video caption may include: separating the video data into the vision data and audio data; and creating the video caption related to the behavior of the object through a multi-modal analysis of a vision mode and an audio mode on the basis of the vision data and the audio data for each of the time-series sections by means of an artificial intelligence model.

The creating of a video caption may include: (a) creating a vision encoder vector and an audio encoder vector through a multi-modal analysis on the basis of the vision data and the audio data by means of an encoder unit; (b) creating a subtitle attention vector by applying self-attention to subtitle data related to the video data on the basis of learned subtitle key values by means of a decoder unit; and (c) creating the video caption by applying multi-modal attention to the subtitle attention vector, the vision encoder vector, and the audio encoder vector by means of the decoder unit.

The step (a) may include: creating a vision attention vector by applying self-attention to the vision data on the basis of learned vision key values; creating an audio attention vector by applying self-attention to the audio data on the basis of learned audio key values; creating the vision encoder vector by inputting the vision attention vector and the audio attention vector into a first multi-modal attention unit; and creating the audio encoder vector by inputting the vision attention vector and the audio attention vector into a second multi-modal attention unit.

The generating of an alarm may include informing a control system of a point in time of occurrence of the dangerous behavior and dangerous behavior information of the object.

The creating of a video caption may include determining the time-series section by setting a behavior stop point on the basis of the vision data.

According to an embodiment of the present disclosure, there is provided a computer program recorded on a computer-readable recording medium to perform the image security method.

An image security system according to an embodiment of the present disclosure includes: a video caption unit configured to create a video caption related to behavior of an object in vision data, which include time-serial image frames constituting video data, from the vision data for each time-series section of the vision data; a behavior analysis unit configured to determine whether the video caption relates to preset dangerous behavior; and an alarm unit configured to generate an alarm notifying of a dangerous situation when the behavior of the object relates to the dangerous behavior.

The video caption unit may be configured to: separate the video data into the vision data and audio data; separate the time-series sections by setting behavior stop points on the basis of the vision data; and create the video caption related to the behavior of the object through a multi-modal analysis of a vision mode and an audio mode on the basis of the vision data and the audio data for each of the time-series sections using an artificial intelligence model.

The video caption unit may include: an encoder unit configured to create a vision encoder vector and an audio encoder vector through a multi-modal analysis on the basis of the vision data and the audio data; and a decoder unit configured to create a subtitle attention vector by applying self-attention to subtitle data related to the video data on the basis of learned subtitle key values, and to create the video caption by applying multi-modal attention to the subtitle attention vector, the vision encoder vector, and the audio encoder vector.

The encoder unit may include: a vision self-attention unit configured to create a vision attention vector by applying self-attention to the vision data on the basis of learned vision key values; an audio self-attention unit configured to create an audio attention vector by applying self-attention to the audio data on the basis of learned audio key values; a first multi-modal attention unit configured to create a first feature vector by performing a multi-modal analysis on the basis of the vision attention vector and the audio attention vector; a second multi-modal attention unit configured to create a second feature vector by performing a multi-modal analysis on the basis of the vision attention vector and the audio attention vector; a first fully connected layer configured to create the vision encoder vector from the first feature vector that is created by the first multi-modal attention unit; and a second fully connected layer configured to create the audio encoder vector from the second feature vector that is created by the second multi-modal attention unit.

### Advantageous Effects

According to the present disclosure, it is possible to detect the behavior of an object on the basis of vision and audio information in a video through an in-video extensive contextual analysis based on multi-modal video captioning, and to automatically provide situation recognition information.

According to the present disclosure, it is possible to replace the manpower that watches a monitoring system by recognizing behavior information of an object in real time in the monitoring system on the basis of a multi-modal video captioning system, and d particularly, it is possible to immediately cope with and manage specific dangerous behavior by immediately generating a warning when sensing the specific dangerous behavior.

### DESCRIPTION OF DRAWINGS

FIG. 1 is a configuration diagram of a video security system according to an embodiment of the present disclosure.

FIG. 2 is a configuration diagram of a video caption unit constituting the video security system according to an embodiment of the present disclosure.

FIG. 3 is a conceptual diagram showing the neural network of an artificial intelligence model according to an embodiment of the present disclosure.

FIG. 4 is a flowchart of an image security method according to an embodiment of the present disclosure.

FIG. 5 is a flowchart showing step S10 in FIG. 4.

### DESCRIPTION OF REFERENCE NUMERALS

100: image security system
110: camera system
120: video caption server
121: vision server
122: audio server
123: video caption unit
124: behavior analysis unit
125: dangerous behavior analysis unit
200: video caption unit
210: encoder unit
211: vision self-attention unit
212: audio self-attention unit
213: first multi-modal attention unit
214: second multi-modal attention unit
215: first fully connected layer
216: second fully connected layer
220, 230: output unit
240: feedback unit
250: decoder unit
251: self-attention unit
252: multimodal attention unit
253: fully connected layer

### MODE FOR INVENTION

Hereafter, the present disclosure is described in detail. However, the present disclosure is not limited or restricted by exemplary embodiments. The objectives and effects of the present disclosure can be naturally understood or made clearer by the following description, but are not limited only to the following description. Further, in description of the present disclosure, well-known technologies are not described in detail when it is determined that detailed description of the well-known technologies may unnecessarily make the point of the present disclosure unclear.

The present disclosure relates to a monitoring system and method that detects behavior of an object in video data on the basis of vision data and audio data in video data through an extensive in-video contextual analysis based on multi-modal video captioning, and automatically provides image situation recognition information.

According to an embodiment of the present disclosure, several CCTVs can extract in real time what crime has occurred in an image through learning of corresponding models in terms of physical security. Further, since learning is performed on the basis of the kinetic information of each person when several people overlap in a specific image section, it is possible to analyze detailed behavior of each of the people.

Further, according to an embodiment of the present disclosure, it is possible to figure out the point in time of occurrence of a crime by generally applying vision data and audio data using a CCTV that receives audio or speaking information, and it is possible to report the point in time of occurrence of a crime and items of dangerous behavior information to a manager in a control system, and generates an alarm.

According to an embodiment of the present disclosure, it is possible to figure out the situation in each section by automatically setting breakpoints of behavior occurrence using all of vision data and audio data through a multi-modal video captioning technology, and it is possible to immediately recognize a situation on the basis of generalized behavior information. Accordingly, it becomes possible to infer extensive information and sudden situations.

According to an embodiment of the present disclosure, items of behavior information in each time-series section are detected on the basis of multiple CCTV images through a multi-modal video caption model implemented in a video caption server of a control system in a monitoring system, and when specific dangerous behavior is sensed, it is reported to a manager and an alarm is sounded, whereby detailed information about a criminal situation is transmitted.

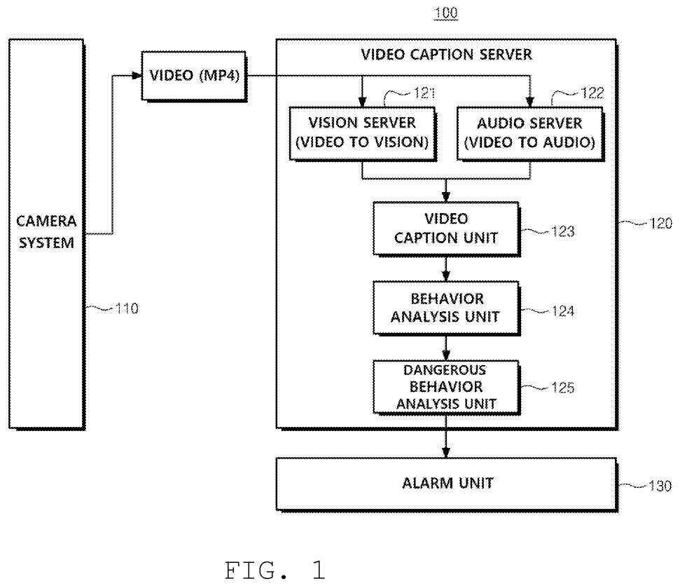

FIG. 1 is a configuration diagram of a video security system according to an embodiment of the present disclosure. Referring to FIG. 1, an image security system 100 according to an embodiment of the present disclosure may include a camera system 110 including one or more cameras that collect video data, a video caption unit 123 creating a video caption (video context) related to behavior of an object in vision data in each time-series section of video data on the basis of multi-modal video captioning from vision data and audio data including time-serial image frames constituting video data collected by the camera system 110, and a behavior analysis unit 124 and a dangerous behavior analysis unit 125 determining whether a video caption created by the video caption unit 123 relates to preset dangerous behavior, and generating an alarm notifying of a dangerous situation when behavior of an object relates to the dangerous behavior.

Video data collected by the camera system 110 can be transmitted to a video caption server 120. The camera of the camera system 110, for example, may be a CCTV camera, but is not necessarily limited thereto.

The video caption server 120 may include a vision server 121 collecting vision data of video data and an audio server 122 collecting audio data of video data.

Vision data collected by the vision server 121 and audio data collected by the audio server 122 can be transmitted to the video caption unit 123. The video caption unit 123 can separate video data into vision data and audio data, separate time-series sections by setting behavior stop points on the basis of vision data, and create a video caption related to behavior of an object through multi-modal analysis of a vision mode and an audio mode on the basis of vision data and audio data for each time-series section using an artificial intelligence model.

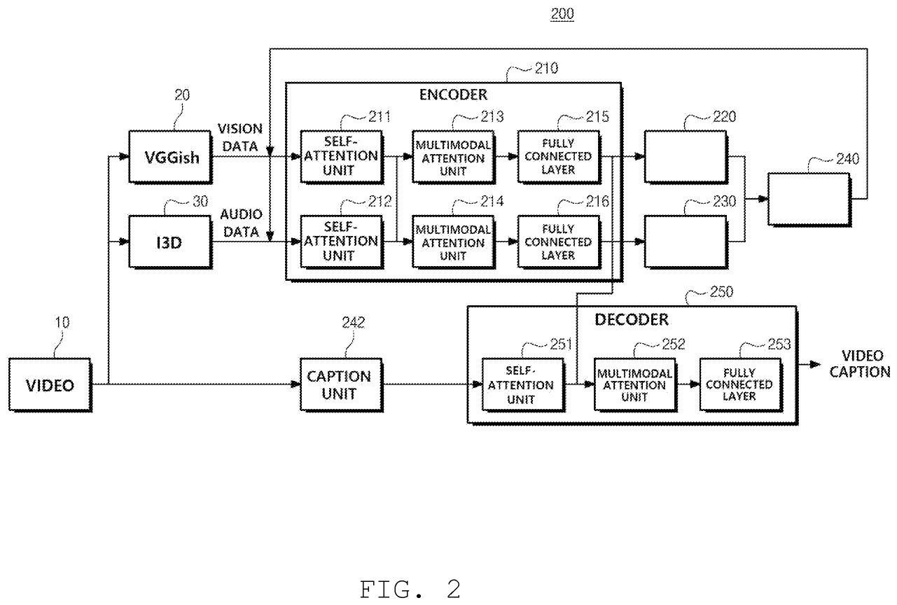

FIG. 2 is a configuration diagram of a video caption unit constituting the video security system according to an embodiment of the present disclosure. Referring to FIGS. 1 and 2, a video caption unit 123, 200 may be configured to input vision data and audio data derived from video data 10 by a VGGish processing unit 20 and an I3D processing unit 30 to an encoder unit 210 of an artificial intelligence model provided in the video caption server 120.

The video caption unit 123, 200 may include an encoder unit 210 creating a vision encoder vector and an audio encoder vector through a multi-modal analysis on the basis of vision data and audio data, and a decoder unit 250 creating a subtitle attention vector by applying self-attention to subtitle data related to video data on the basis of learned subtitle key values, and creating a video caption by applying multi-modal attention to a subtitle attention vector, a vision encoder vector, and an audio encoder vector.

The encoder unit 210 may include a vision self-attention unit 211 creating a vision attention vector by applying self-attention to vision data on the basis of learned vision key values, an audio self-attention unit 212 creating an audio attention vector by applying self-attention to audio data on the basis of learned audio key values, a first multi-modal attention unit 213 creating a first feature vector by performing a multi-modal analysis on the basis of a vision attention vector and an audio attention vector, a second multi-modal attention unit 214 creating a second feature vector by performing a multi-modal analysis on the basis of a vision attention vector and an audio attention vector, a first fully connected layer 215 creating a vision encoder vector from the first feature vector crated by the first multi-modal attention unit 213, and a second fully connected layer 216 creating an audio encoder vector from the second feature vector created by the second multi-modal attention unit 214.

The artificial intelligence model constituting the video caption unit 123 of the video caption server 120 may include output units 220 and 230 outputting output values of the encoder unit 210, and a feedback unit 240 feedbacking output values of the output units 220 and 230 to an input terminal of the encoder unit 210 to learn the artificial intelligence model.

The decoder unit 250 may include a self-attention unit 251 creating a subtitle attention vector by applying self-attention to subtitle data related to video data on the basis of learned subtitle key values, a multimodal attention unit 252 applying multi-modal attention to the subtitle attention vector created by the self-attention unit 251 and the vision encoder vector and the audio encoder vector created by the encoder unit 210, and a fully connected layer 253 creating and outputting a video caption from a multi-modal attention-processed feature vector. The subtitle data related to video data may be obtained by a caption unit 242.

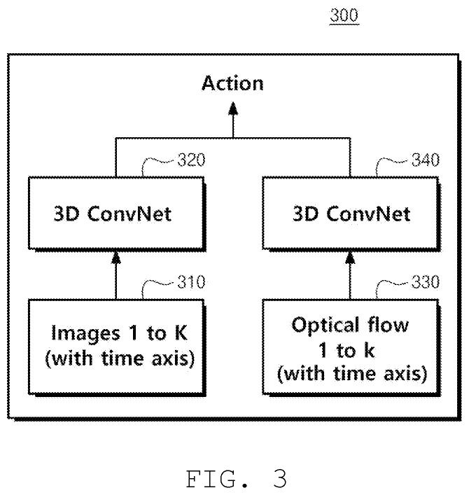

FIG. 3 is a conceptual diagram showing the neural network of an artificial intelligence model according to an embodiment of the present disclosure. Referring to FIGS. 1 to 3, a neural network 300 of the image security system according to an embodiment of the present disclosure may be provided in Two-Stream 3D-ConvNet architectures 320 and 340 obtained by expanding a 2D-type neural network into a 3D type of 1024-d Feature. The neural network of the artificial intelligence according to an embodiment of the present disclosure may be implemented to maximize performance by taking a pretrained weight from an ImageNet 310, and can figure in-video behavior and motion information on the basis of RGB and an optical flow 330.

An audio analysis deep learning model VGGish, which is a model learned from a large-scale YouTube dataset, can learn a sorter for a multiple audioset class when analyzing in-image audio and inferring what category it is, and can convert it into 128-d Feature and provide the 128-d Feature as input to a downstream classification model.

Feature values of an I3D model and a VGGish model can be configured into a multi-modal type in a vanilla transformer architecture and can undergo distillation and pruning for lightweighting, and it is possible automatically detect behavior events and create video caption information in an artificial intelligence model. Accordingly, it is possible to easily figure out the context in each section by automatically setting breakpoints (behavior stop points) using all of vision and audio information through an extensive contextual analysis and a multi-modal analysis.

In the case of a C3D (3D ConvNet) architecture that uses 3D for understanding a video, since there are many parameters, training is difficult. Further, since there are many convolutional layers, the amount of operations is overwhelmingly large, it is difficult to expect good performance. Since the I3D architecture that is used in accordance with an embodiment of the present disclosure is, unlike a C3D architecture, a concept expanding 2D into 3D by adding an optical flow, it is possible to intactly take ImageNet pretrained weight, whereby it is possible to expect performance improvement in terms of expandability, accessibility, and accuracy.

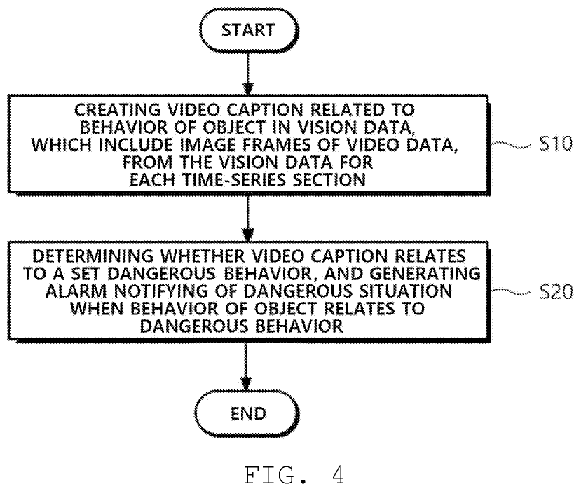

FIG. 4 is a flowchart of an image security method according to an embodiment of the present disclosure. Referring to FIGS. 1, 2, and 4, an image security method according to an embodiment of the present disclosure may include a step of creating a video caption related to behavior of an object in vision data, which include time-serial image frames constituting video data, from the vision data for each time-series section of the vision data by means of the video caption unit 200 (S10), and a step of determining whether the video caption relates to preset dangerous behavior and generating an alarm notifying of a dangerous situation through the alarm unit 130 when the behavior of the object relates to the dangerous behavior by means of a behavior analysis unit 124 and a dangerous behavior analysis unit 125 (S20).

The step of creating a video caption (S10) may include a step of separating video data into the vision data and audio data and a step of creating a video caption related to the behavior of the object through a multi-modal analysis of a vision mode and an audio mode on the basis of the vision data and the audio data for each of the time-series sections by means of an artificial intelligence model.

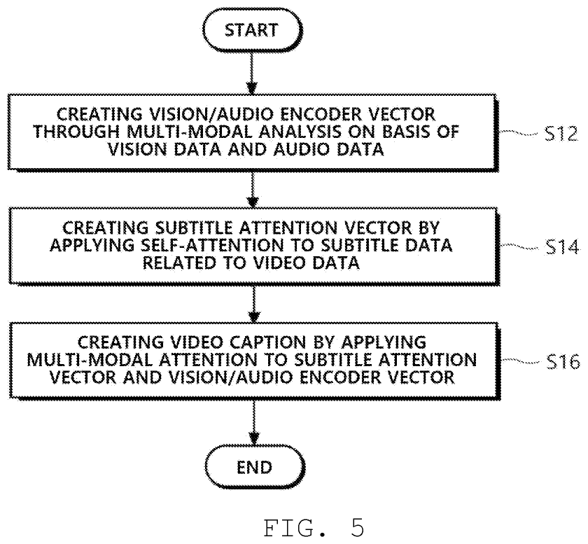

FIG. 5 is a flowchart showing step S10 in FIG. 4. Referring to FIGS. 2, 4, and 5, the step of creating a video caption (S10) may include a step of creating a vision encoder vector and an audio encoder vector through a multi-modal analysis on the basis of the vision data and the audio data by means of the encoder unit 210 (S12), a step of creating a subtitle attention vector by applying self-attention to subtitle data related to the video data on the basis of learned subtitle key values by means of a decoder unit 250 (S14), and a step of creating the video caption by applying multi-modal attention to the subtitle attention vector, the vision encoder vector, and the audio encoder vector (S16).

The step S12 may include a step of creating a vision attention vector by applying self-attention to vision data, a step of creating a vision attention vector by applying self-attention to the vision data on the basis of learned vision key values, a step of creating an audio attention vector by applying self-attention to the audio data on the basis of learned audio key values, a step of creating a vision encoder vector by inputting the vision attention vector and the audio attention vector to a first multi-modal attention unit, and a step of creating an audio encoder vector by inputting the vision attention vector and the audio attention vector to a second multi-modal attention unit.

The step of creating a vision caption (S10) may include a step of determining a time-series section by setting a behavior stop point on the basis of vision data of video data. The step of generating an alarm (S20) may include a step of informing a control system of the point in time of occurrence of dangerous behavior and dangerous behavior information of an object.

Unless orders are clearly described for steps of the method according to the present disclosure or there is opposed description, the steps can be performed in appropriate order. The present disclosure is not necessarily limited to the described order of the steps.

All examples or exemplary terms (e.g., etc.) stated herein are used to describe the present disclosure in detail and the range of the present disclosure is not limited by the examples or the terms unless they are limited by claims. It would be understood by those skilled in the art that the present disclosure may be configured in accordance with design conditions and factors within claims having various changes, combinations, and modifications or an equivalent range.

Therefore, the spirit of the present disclosure should not be limited to the above-described embodiments, and not only the following claims, but all ranges modified equally or equivalently to the claims are intended to fall within the scope and spirit of the present disclosure.

Although the present disclosure was described above with reference to the exemplary embodiments shown in the drawings, those are only examples and it would be understood by those skilled in the art that various changes and modifications of embodiments may be achieved from the above exemplary embodiments. Therefore, the technical protective region of the present disclosure should be determined by the spirit described in claims.

1. An image security method comprising:
creating a video caption related to behavior of an object in vision data, which include time-serial image frames constituting video data, from the vision data for each time-series section of the vision data by means of a video caption unit;
determining whether the video caption relates to preset dangerous behavior by means of a behavior analysis unit; and
generating an alarm notifying of a dangerous situation by means of an alarm unit when the behavior of the object relates to the dangerous behavior,
wherein the creating of a video caption includes:
separating the video data into the vision data and audio data by means of the video caption unit; and
creating the video caption related to the behavior of the object through a multi-modal analysis of a vision mode and an audio mode on the basis of the vision data and the audio data for each of the time-series sections by means of an artificial intelligence model of the video caption unit,
the creating of a video caption includes:
(a) creating a vision encoder vector and an audio encoder vector through a multi-modal analysis on the basis of the vision data and the audio data by means of an encoder unit;
(b) creating a subtitle attention vector by applying self-attention to subtitle data related to the video data on the basis of learned subtitle key values by means of a decoder unit; and
(c) creating the video caption by applying multi-modal attention to the subtitle attention vector, the vision encoder vector, and the audio encoder vector by means of the decoder unit,
wherein the step (a) includes:
creating a vision attention vector by applying self-attention to the vision data on the basis of learned vision key values by means of a vision self-attention unit;
creating an audio attention vector by applying self-attention to the audio data on the basis of learned audio key values by means of an audio self-attention unit;
creating a first feature vector by performing a multi-modal analysis on the basis of the vision attention vector and the audio attention vector by means of a first multi-modal attention unit by inputting the vision attention vector and the audio attention vector into the first multi-modal attention unit, and creating the vision encoder vector from the first feature vector, which is created by the first multi-modal attention unit, by means of a first fully connected layer; and
creating a second feature vector by performing a multi-modal analysis on the basis of the vision attention vector and the audio attention vector by means of a second multi-modal attention unit by inputting the vision attention vector and the audio attention vector into the second multi-modal attention unit, and creating the audio encoder vector from the second feature vector, which is created by the second multi-modal attention unit, by means of a second fully connected layer,
the generating of an alarm includes informing a control system of a point in time of occurrence of the dangerous behavior and dangerous behavior information of the object by means of the alarm unit, and
the creating of a video caption further includes determining the time-series section by setting a behavior stop point on the basis of the vision data by means of the video caption unit.

2. A computer program recorded on a computer-readable recording medium to perform the image security method of claim 1.

3. An image security system comprising:
a video caption unit configured to create a video caption related to behavior of an object in vision data, which include time-serial image frames constituting video data, from the vision data for each time-series section of the vision data;
a behavior analysis unit configured to determine whether the video caption relates to preset dangerous behavior; and
an alarm unit configured to generate an alarm notifying of a dangerous situation when the behavior of the object relates to the dangerous behavior,
wherein the video caption unit is configured to:
separate the video data into the vision data and audio data;
separate the time-series sections by setting behavior stop points on the basis of the vision data; and
create the video caption related to the behavior of the object through a multi-modal analysis of a vision mode and an audio mode on the basis of the vision data and the audio data for each of the time-series sections using an artificial intelligence model,
the video caption unit further includes:
an encoder unit configured to create a vision encoder vector and an audio encoder vector through a multi-modal analysis on the basis of the vision data and the audio data; and
a decoder unit configured to create a subtitle attention vector by applying self-attention to subtitle data related to the video data on the basis of learned subtitle key values, and to create the video caption by applying multi-modal attention to the subtitle attention vector, the vision encoder vector, and the audio encoder vector,
the encoder unit includes:
a vision self-attention unit configured to create a vision attention vector by applying self-attention to the vision data on the basis of learned vision key values;
an audio self-attention unit configured to create an audio attention vector by applying self-attention to the audio data on the basis of learned audio key values;
a first multi-modal attention unit configured to create a first feature vector by performing a multi-modal analysis on the basis of the vision attention vector and the audio attention vector;
a second multi-modal attention unit configured to create a second feature vector by performing a multi-modal analysis on the basis of the vision attention vector and the audio attention vector;
a first fully connected layer configured to create the vision encoder vector from the first feature vector that is created by the first multi-modal attention unit; and
a second fully connected layer configured to create the audio encoder vector from the second feature vector that is created by the second multi-modal attention unit, and
the alarm unit is configured to inform a control system of a point in time of occurrence of the dangerous behavior and dangerous behavior information of the object.
